(19) United States
(12) Patent Application Publication
(10) Pub. No.: US 2026/0112022 A1
(43) Pub. Date: Apr. 23, 2026

(54) DETERMINATION APPARATUS, TRAINING APPARATUS, DETERMINATION METHOD, TRAINING METHOD, DETERMINATION PROGRAM, AND TRAINING PROGRAM

(71) Applicant: Nitto Denko Corporation, Ibaraki-shi, Osaka (JP)

(72) Inventors: Ryosuke Hiramoto, Osaka (JP); Yoichi Kigawa, Osaka (JP); Asami Narukawa, Mie (JP)

(73) Assignee: Nitto Denko Corporation, Ibaraki-shi, Osaka (JP)

(21) Appl. No.: 19/141,629

(22) PCT Filed: Mar. 28, 2024
(86) PCT No.: PCT/JP2024/012794

§ 371 Date: Jun. 20, 2025

(30) Foreign Application Priority Data
Mar. 29, 2023 (JP) 2023-054111

(51) Int. Cl. G06T 7/00; G06T 5/50

(52) U.S. Cl. CPC G06T 7/001; G06T 5/50; G06T 2207/20221; G06T 2207/30141

(57) ABSTRACT

To reduce false positive determinations in an inspection system. A determination apparatus includes a trained image reconstructing unit trained such that a first reconstruction image more closely resembles a first image and configured to output the first reconstruction image, in a case where a first mask image is input into the trained image reconstructing unit, the first mask image being generated by overlaying a mask onto an inspection region of the first image, the first image being an image determined not to contain a defect among captured images of an inspection target object, a synthesizing unit configured to generate a second synthesized image by synthesizing a plurality of second reconstruction images in a case where the plurality of second reconstruction images are reconstructed by inputting a plurality of second mask images into the trained image reconstructing unit, the plurality of second mask images generated by a plurality of masks being successively overlaid onto an inspection region of a second image, the second image being a captured image of the inspection target object, and a determination unit configured to compare the second synthesized image with the second image to determine whether or not the second image contains a defect.

### TECHNICAL FIELD

The present disclosure relates to a determination apparatus, a training apparatus, a determination method, a training method, a determination program, and a training program.

### BACKGROUND ART

There is a known inspection system in which a human inspector performs a visual inspection (i.e., visual inspection performed by looking directly at the image with the naked eye), on images determined to contain defects, among inspection images acquired by capturing images of inspection target objects such as printed circuit boards, in order to determine whether the inspection target object is a defect-free product or a defective product.

With this inspection system, image generation artificial intelligence (AI) or the like, that is trained so as to reconstruct normal images, for example, can be applied to make a determination as to whether or not the inspection image contains a defect.

With this image generation AI, a determination is made as to whether or not an inspection image is a normal image by reconstructing an image referred to as a reconstruction image from a masked inspection image created by overlaying a mask onto an inspection image, and then comparing the reconstruction image with the inspection image. Therefore, even if a new type of defect occurs, this image generation AI can make an appropriate determination.

### CITATION LIST

### Patent Literature

Patent Literature 1: Unexamined Japanese Patent Application Publication No. 2022-114331

### SUMMARY OF INVENTION

### Technical Problem

However, in the case of inspection target objects such as that mentioned above, there are instances where manufacturing variations or the like occur that fall within the acceptable range for defect-free products. In such a case, since the difference between the inspection image and the reconstruction image is large, in the image generation AI mentioned above, there is a possibility that an inspection image is falsely determined (i.e., a false positive determination is made) to contain a defect a defect even though the inspection image is a normal image.

In one aspect, it is an object to reduce false positive determinations in an inspection system.

### Solution to Problem

One aspect of the present disclosure is a determination apparatus that includes:
a trained image reconstructing unit trained such that a first reconstruction image more closely resembles a first image and configured to output the first reconstruction image, in a case where a first mask image is input into the trained image reconstructing unit, the first mask image being generated by overlaying a mask onto an inspection region of the first image, the first image being an image determined not to contain a defect among captured images of an inspection target object;
a synthesizing unit configured to generate a second synthesized image by synthesizing a plurality of second reconstruction images in a case where the plurality of second reconstruction images are reconstructed by inputting a plurality of second mask images into the trained image reconstructing unit, the plurality of second mask images generated by a plurality of masks being successively overlaid onto an inspection region of a second image, the second image being a captured image of the inspection target object; and
a determination unit configured to compare the second synthesized image with the second image to determine whether or not the second image contains a defect.

### Advantageous Effects of Invention

False positive determinations in the inspection system can be reduced.

### BRIEF DESCRIPTION OF DRAWINGS

FIG. 1A is a diagram for describing an example of a training processing method of a comparative example for image generation AI.

FIG. 1B is a diagram for describing an example of a determination processing method of a comparative example when determining whether or not there is a defect by using a trained image generation AI.

FIG. 2 is a diagram illustrating an example of a false positive determination.

FIG. 3A is a diagram illustrating an example of a training processing method for an image generation AI in an inspection system according to a first embodiment.

FIG. 3B is a first drawing illustrating an example of a determination processing method for determining whether or not there is a defect by using a trained image generation AI in the inspection system according to the first embodiment.

FIG. 4 is a diagram illustrating an example of a system configuration of an inspection system in a training phase according to the first embodiment.

FIG. 5 is a diagram illustrating an example of a hardware configuration of a training apparatus.

FIG. 6 is a diagram illustrating a specific example of processing performed by a training dataset generation unit of the training apparatus.

FIG. 7 is a diagram illustrating a specific example of processing performed by the training unit of the training apparatus.

FIG. 8 illustrates an example of the system configuration of the inspection system in an inspection phase according to the first embodiment.

FIG. 9 illustrates an example of the hardware configuration of a determination apparatus.

FIG. 10 illustrates a specific example of the processing performed by an inference unit of the determination apparatus.

FIG. 11 is a flowchart illustrating the flow of the training processing performed by the training apparatus of the inspection system according to the first embodiment.

FIG. 12 is a flowchart illustrating the flow of determination processing performed by the determination apparatus of the inspection system according to the first embodiment.

FIG. 13 is a diagram for describing an overview of verification processing.

FIG. 14 is a diagram illustrating an example of verification results.

FIG. 15 is a diagram illustrating other examples of a first mask and multiple second masks.

### DESCRIPTION OF EMBODIMENTS

Each embodiment is described below with reference to the attached drawings. In the present specification and the drawings, components having substantially the same functional configuration are denoted by the same reference numerals and thus duplicate descriptions are omitted.

### First Embodiment

### <Description of Training Processing Method and Determination Processing Method of Comparative Example for Image Generation AI

As is described further below, in an inspection system according to the first embodiment, a training processing method and a determination processing method different from a general training processing method and a general determination processing method are applied to the image generation AI in order to reduce false positive determinations.

Therefore, the general training processing method and the general determination processing method (referred to as a training processing method and a determination processing method of the comparative example) for the image generation AI is described below first. Thereafter, cases in which false positive determination occurs in the training processing method and the determination processing method of the comparative example is described, and then the training processing method and the determination processing method for the image generation AI in the inspection system according to the first embodiment that can reduce false positive determinations is described.

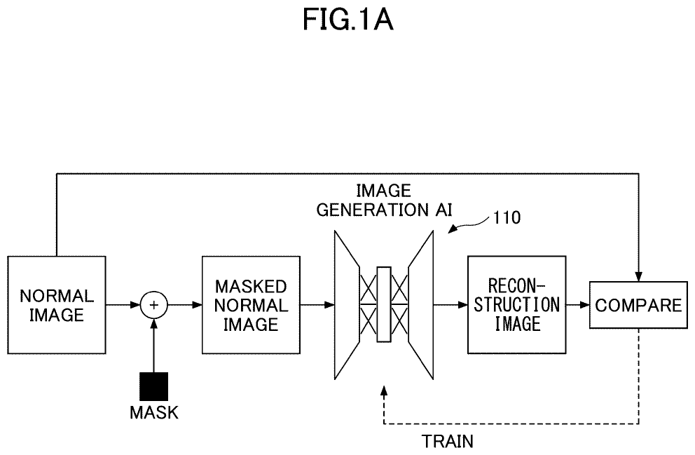

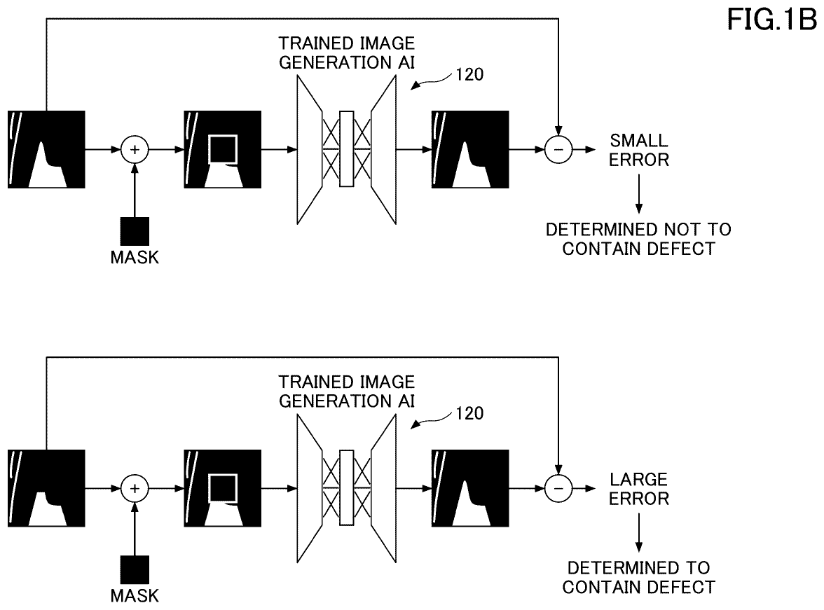

FIG. 1A is a diagram for describing an example of the training processing method of the comparative example for the image generation AI. As illustrated in FIG. 1A, in the case of the training processing method of the comparative example, training processing is performed for an image generation AI 110 in the following procedure.
An inspection image of an inspection target object determined to be a defect-free product (referred to as a normal image), among images captured in the inspection system, is acquired, and a masked normal image is generated by overlaying a mask on an inspection region.
By inputting the generated masked normal image into the image generation AI 110, the reconstruction image output from the image generation AI 110 is compared with the normal image to calculate an error.
The model parameters of the image generation AI 110 are updated such that the calculated error becomes smaller. This processing is performed on multiple normal images to perform training processing on the image generation AI 110, thereby generating the trained image generation AI.

Next, the determination processing method of the comparative example when determining whether or not the inspection image contains a defect by using the generated trained image generation AI is described.

FIG. 1B is a diagram for describing an example of the determination processing method of the comparative example when determining whether or not there is a defect by using the trained image generation AI. As illustrated in the upper part of FIG. 1B, in the case of the comparative example, the determination processing is performed by the following procedure using a trained image generation AI 120, and it is determined that there is no defect.
A masked inspection image is generated by acquiring an inspection image captured in the inspection system and overlaying a mask on an inspection region.
The generated masked inspection image is input into the trained image generation AI 120, and the trained image generation AI 120 outputs a reconstruction image.
The error between the reconstruction image output by the trained image generation AI 120 and the inspection image is calculated, and the result indicating that the error is small is acquired. Since the trained image generation AI 120 is trained so as to reconstruct the normal image for the input masked inspection image, the reconstruction image output by the trained image generation AI 120 closely resembles the normal image.
Therefore, if the calculated error is small, the inspection image can be regarded as an image that closely resembles the normal image. As a result, it can be determined that the inspection image does not contain a defect.

On the other hand, as illustrated in the lower part of FIG. 1B, in the case of the comparative example, the determination processing is performed by using the trained image generation AI 120 in the following procedure, and it is determined that there is a defect.
A masked inspection image is generated by acquiring an inspection image captured in the inspection system and overlaying a mask on the inspection region.
By inputting the generated masked inspection image is input into the trained image generation AI 120, the trained image generation AI 120 outputs a reconstruction image.
The error between the reconstruction image output by the trained image generation AI 120 and the inspection image is calculated, and the result indicating that that the error is large is acquired. As described above, since the trained image generation AI 120 is trained to reconstruct the normal image for the input masked inspection image, the reconstruction image output by the trained image generation AI 120 closely resembles the normal image.
Therefore, if the calculated error is large, the inspection image can be regarded as being far from the normal image. As a result, it can be determined that the inspection image contains a defect.

In FIG. 1B, for the sake of simplicity of description, it is assumed that a determination is made as to whether or not the inspection image contains a defect based on the size of the calculated error. However, the determination made as to whether or not the inspection image contains a defect is not limited to this. For example, it is possible to perform image processing by using the inspection image and the reconstruction image, and make a determination based on the result of the image processing. However, in this embodiment, for the sake of simplicity of description, the case in which a determination is made as to whether or not the inspection image contains a defect based on the size of the calculated error is described.

### <Description of False Positive Determination>

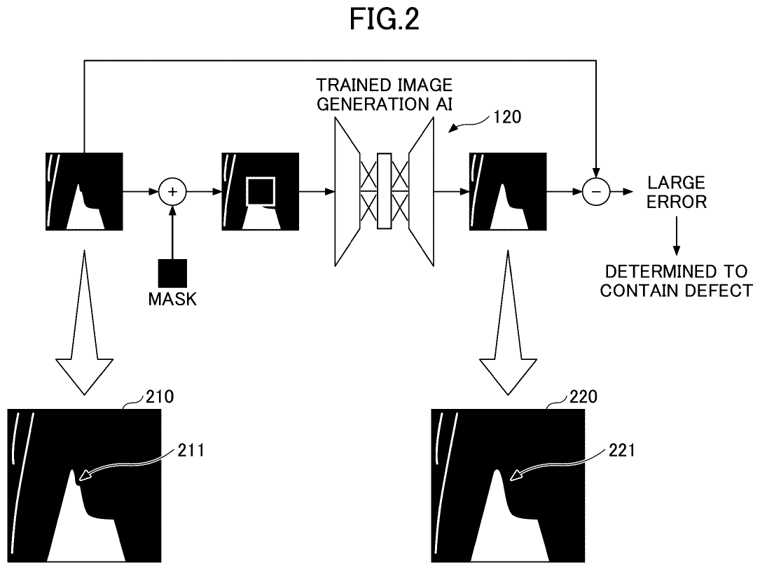

Next, a case where an inspection image that ought to be determined not to contain a defect by the trained image generation AI 120 is falsely determined (i.e., a false positive determination is made) to contain a defect is described. FIG. 2 is a diagram illustrating an example of a false positive determination.

In FIG. 2, an inspection image 210 is an example of an inspection image that does not contain a defect but was falsely determined to contain a defect by a trained image generation AI 120. An inspection target object corresponding to the inspection image 210 has the following features:
In the inspection region, there is a partial shape change in the inspection target object (reference numeral 211).
This partial shape change in the inspection target object is due to a manufacturing variation yet falls within an acceptable range for defect-free products.

In the case of the inspection image 201, when the inspection image 210 overlaid with a mask is input into the trained image generation AI 120, a reconstruction image 220 illustrated in FIG. 2, for example, is output from the trained image generation AI 120. As illustrated in FIG. 2, the reconstruction image 220 output by the trained image generation AI 120 is a typical normal image and partial shape change in the inspection target could not be reconstructed (see reference numeral 221).

Therefore, when the reconstruction image 220 is compared with the inspection image 210, the error between the two is large, leading to a false determination that the inspection image 210 contains a defect.

To cope with such a case, the inspection system according to the first embodiment has the following configuration so as to reduce false positive determinations.
A first mask, in which multiple mask pieces smaller in size than a mask to be overlaid onto the inspection region are orderly arranged such that neighboring mask pieces among the multiple mask pieces have a predetermined space therebetween (an integer multiple of the size of the mask piece) in a vertical direction, a horizontal direction, and a diagonal direction, is generated.
Multiple second masks in which multiple mask pieces are orderly arranged at positions so as to occupy the predetermined spaces of the first mask in the vertical direction, the horizontal direction, and the diagonal direction. The second mask is generated in a quantity corresponding to the size of the spaces.
Multiple reconstruction images are reconstructed by inputting the image in which the first mask and the multiple second masks are successively overlaid (masked inspection image) into the trained image generation AI.
A synthesized image is generated by synthesizing the multiple reconstructed reconstruction images.

By having the above-described configuration, the inspection system according to the first embodiment makes it possible to reconstruct a partial shape change in the inspection target object that arose due to a manufacturing variation that is within the acceptable range of a defect-free product, thereby reducing false positive determinations.

<training Processing Method for Image Generation AI in Inspection System According to First Embodiment>

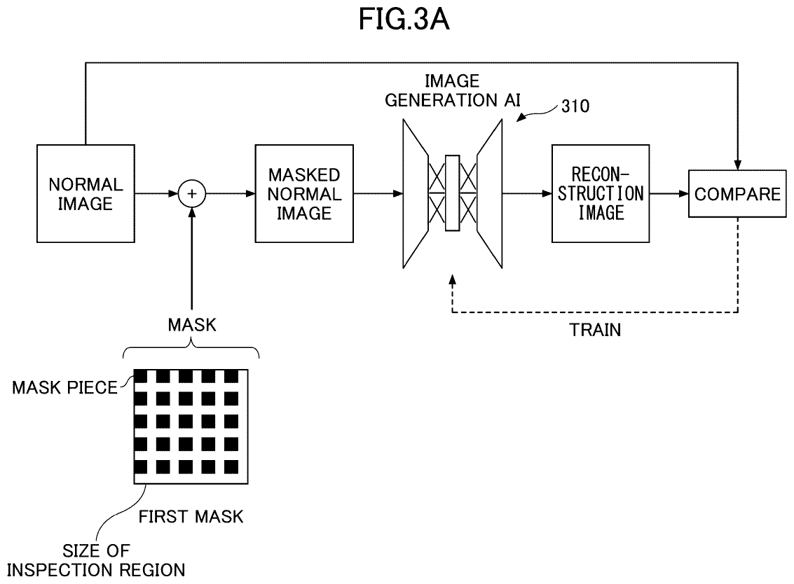

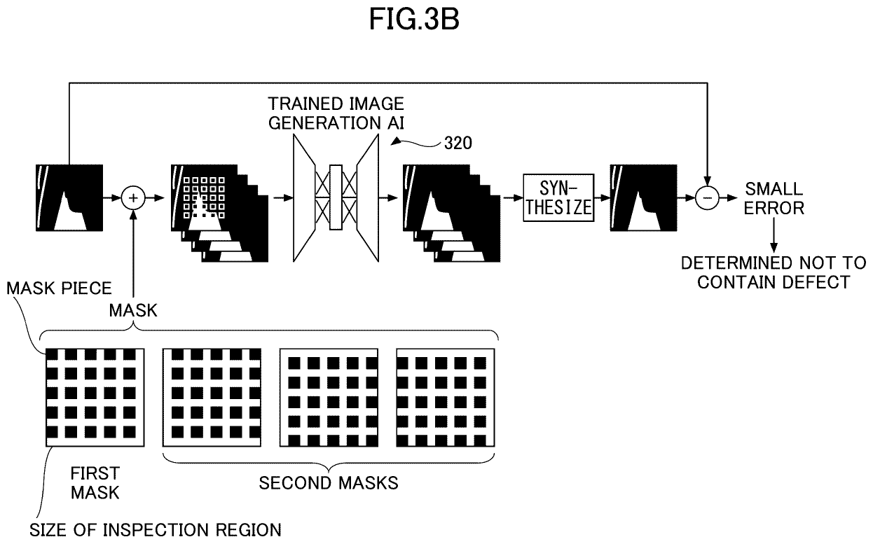

A training processing method for image generation AI in the inspection system according to the first embodiment is described. FIG. 3A is a diagram illustrating an example of a training processing method for image generation AI in the inspection system according to the first embodiment.

The difference from the training processing method of the comparative example illustrated in FIG. 1A is that in FIG. 3A, the mask to be used as the mask used to generate the masked normal image input into an trained image generation AI 310 includes:
a first mask, in which multiple mask pieces smaller in size than a mask to be overlaid onto the inspection region are orderly arranged such that neighboring mask pieces among the multiple mask pieces have a predetermined space therebetween (an integer multiple of the size of the mask piece) in a vertical direction, a horizontal direction, and a diagonal direction.

This training processing method makes it possible for the inspection system according to the first embodiment to generate a trained image generation AI that is capable of reconstructing a partial shape change in the inspection target object that arose due to a manufacturing variation that is within the acceptable range of a defect-free product.

Next, a determination processing method for determining whether or not there is a defect using trained image generation AI in the inspection system according to the first embodiment is described.

FIG. 3B is a first drawing illustrating an example of a determination processing method for determining whether or not there is a defect by using the trained image generation AI in the inspection system according to the first embodiment. The differences from FIG. 1B are as follows. In the case of FIG. 3B:
a first mask, in which multiple mask pieces smaller in size than a mask to be overlaid onto the inspection region are orderly arranged such that neighboring mask pieces among the multiple mask pieces have a predetermined space therebetween (an integer multiple of the size of the mask piece) in a vertical direction, a horizontal direction, and a diagonal direction, and
three types of the second mask in which multiple mask pieces are orderly arranged at positions so as to occupy the predetermined spaces of the first mask in the vertical direction, the horizontal direction, and the diagonal direction, are included.

Also, the differences from the determination processing method of the comparative example illustrated in 1B are that in FIG. 3B,
four reconstruction images are reconstructed by inputting four masked inspection images in which the first mask and the three types of the second mask are successively overlaid into a trained image generation AI 320, and
a synthesized image is generated by synthesizing the four reconstructed reconstruction images.

This determination processing method makes it possible for the inspection system according to the first embodiment to reconstruct the partial shape change in the inspection target object that arose due to a manufacturing variation that is within the acceptable range of a defect-free product, thereby making the error between the inspection image and the synthesized image smaller. As a result, the inspection image is determined not to contain the defect (the issue of the inspection image being falsely determined to contain a defect no longer happens), and thus false positive determinations can be reduced.

### <System Configuration of Inspection System (Training Phase)>

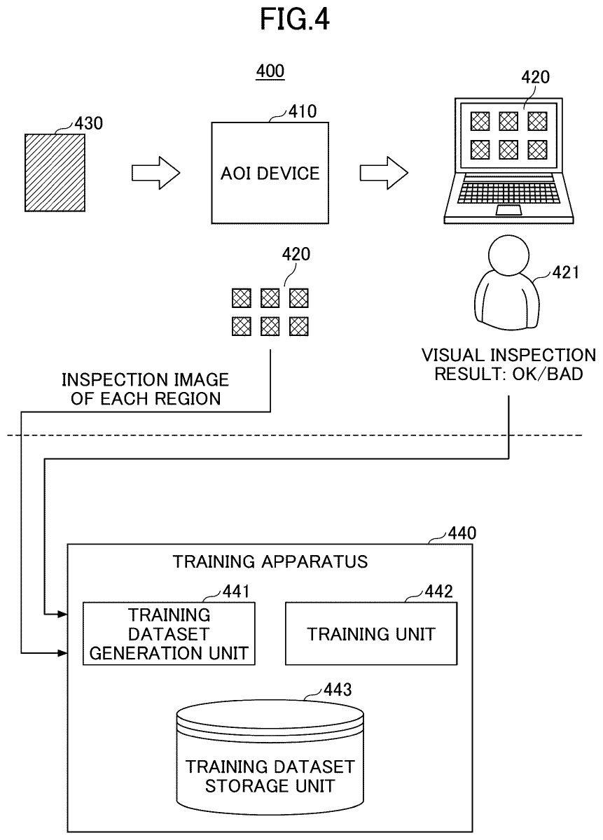

Next, a system configuration of the inspection system in the training phase according to the first embodiment to which the image generation AI is applied is described. FIG. 4 is a diagram illustrating an example of the system configuration of the inspection system in the training phase according to the first embodiment.

As illustrated in FIG. 4, an inspection system 400 in the training phase includes an automated optical inspection (AOI) device 410 and a training apparatus 440.

The AOI device 410 performs automatic visual inspection of the printed circuit board 430. The AOI device 410 detects a defect candidate by scanning the printed circuit board 430 with a camera and inspecting various inspection items. The inspection items checked by the AOI device 410 include, for example, circuit width, circuit spacing, missing pads/no pads, circuit shorts, and the like.

An inspection image 420 of each region containing a defect candidate detected by the AOI device 410 is transmitted to the training apparatus 440 and to the inspection line. In the inspection line, a human inspector 421 or the like performs visual inspection of the inspection image 420 of each region containing a defect candidate. It is assumed that the AOI device 410 is set so that the inspection image of each region containing a defect candidate is detected with an intentionally high sensitivity so that defective products are not determined to be defect-free products.

The human inspector 421 or the like performs visual inspection to determine whether or not the inspection image 420 of each region includes a defect, and ultimately determines whether the printed circuit board 430 is a defect-free product or a defective product. Specifically, if there is no defect in any of the inspection images 420 of the regions containing defect candidates, the printed circuit board 430 is determined to be a defect-free product. If any defect is included in any of the inspection images 420 of the regions containing the defect candidates, the printed circuit board 430 is determined to be a defective product.

The human inspector 421 or the like notifies the training apparatus 440 of the result of the visual inspection (results of determining whether defect is included in inspection image 420 of each region). In the example illustrated in FIG. 1, “visual inspection result: OK” indicates that the image of the region containing the defect candidate does not contain any defects, whereas “visual inspection result: BAD” indicates that an image of the region containing the defect candidate contains a defect.

A training program is installed in the training apparatus 440, and the training apparatus 440 functions as a training dataset generation unit 441 and a training unit 442 by executing the program.

The training dataset generation unit 441 extracts the inspection image (normal image) that is determined not to contain a defect as the result of the visual inspection by the human inspector 421 or the like among the inspection images 420 of each region containing the defect candidate transmitted from the AOI device 410, and generates a training dataset. Also, the training dataset generation unit 441 stores the generated trained dataset in a training dataset storage unit 443.

The training unit 442 reads the inspection image (normal image) of each region included in the training dataset stored in the training dataset storage unit 443. The training unit 442 generates a masked normal image by overlaying the first mask onto the inspection region of the extracted inspection image (normal image) of each region. The training unit 442 also performs training processing on the model that is to output the reconstruction image, in a case where the generated masked normal image is input such that the reconstruction image more closely resembles the normal image.

The model for which training processing is performed by the training unit 442 uses the image generation AI described above. Hereinafter, the model is referred to as the “image reconstructing unit”.

### <Hardware Configuration of Training Apparatus>

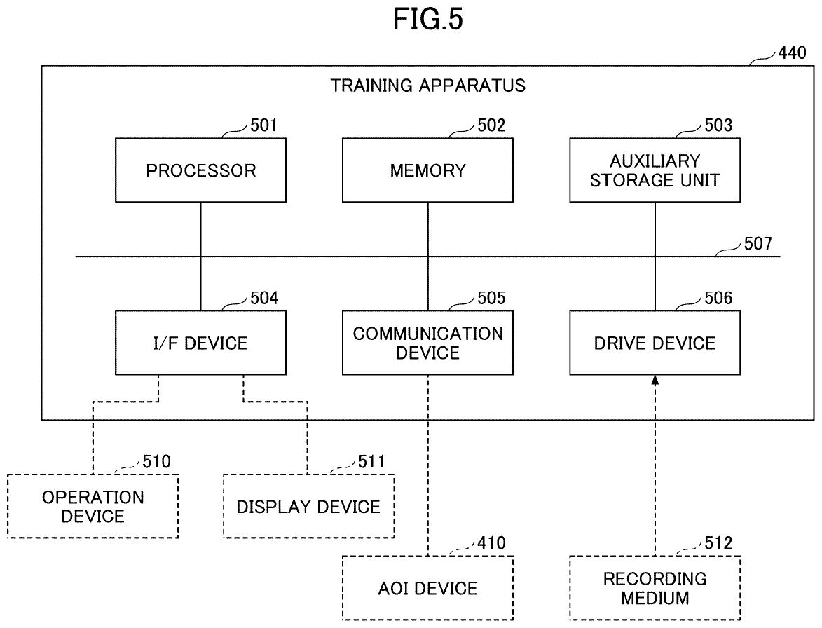

Next, the hardware configuration of the training apparatus 440 is described. FIG. 5 illustrates an example of the hardware configuration of the training apparatus. As illustrated in FIG. 5, the training apparatus 440 has a processor 501, a memory 502, an auxiliary storage device 503, an interface (I/F) device 504, a communication device 505, and a drive device 506. Each hardware component of the training apparatus 440 is interconnected via a bus 507.

The processor 501 includes various computing devices such as a central processing unit (CPU) and a graphics processing unit (GPU). The processor 501 reads various programs (for example, training program) into the memory 502 and executes them.

The memory 502 has main storage devices such as read-only memory (ROM) and random access memory (RAM). The processor 501 and the memory 502 form what is known as a computer. When the processor 501 executes various programs read into the memory 502, the computer achieves, for example, the functions (training dataset generation unit 441 and training unit 442) described above.

The auxiliary storage device 503 stores various programs and various data used when the various programs are executed by the processor 501. For example, the training dataset storage unit 443 is implemented in the auxiliary storage device 503.

The I/F device 504 is a connection device that connects an operation device 510 and a display device 511, which are examples of external devices, to the training apparatus 440. The I/F device 504 receives operations (for example, the operation of inputting the result of visual inspection by the human inspector 421 or the like, or the operation of inputting the instructions of training processing given by a person, i.e. a manager (not illustrated) who manages the training apparatus 440) performed with respect to the training apparatus 440 via the operation device 510. The I/F device 504 outputs the results of training processing performed by the training apparatus 440 and displays them to the manager of the training apparatus 440 via the display device 511.

The communication device 505 is a communication device for communicating with other devices (in this embodiment, the AOI device 410).

The drive device 506 is a device in which the recording medium 512 is set. The recording medium 512 here includes a medium for recording information optically, electrically, or magnetically, such as a CD-ROM, a flexible disk, or a magneto-optical disk. The recording medium 512 may also include a semiconductor memory for recording information electrically, such as a ROM, flash memory, or the like.

The various programs installed in the auxiliary storage device 503 are installed, for example, when the distributed recording medium 512 is set in the drive device 506 and the various programs recorded in the recording medium 512 are read by the drive device 506. Alternatively, the various programs installed in the auxiliary storage device 503 may be installed by downloading them from the

### <Details of Each Unit of Training Apparatus>

Next, details of each unit (training dataset generation unit 441 and training unit 442) of the training apparatus 440 is described.

### (1) Specific Example of Processing Performed by Training Dataset Generation Unit

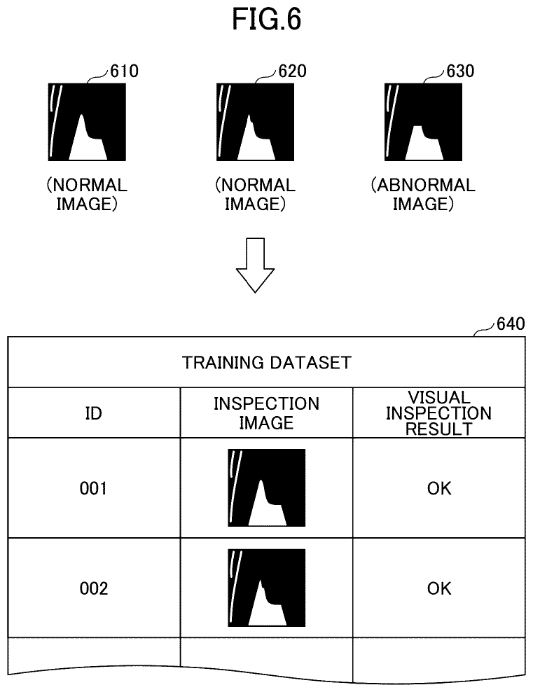

FIG. 6 illustrates a specific example of processing performed by the training dataset generation unit of the training apparatus. As illustrated in FIG. 6, when inspection images 610 to 630 of each region containing a defect candidate are transmitted from the AOI device 410, for example, the training dataset generation unit 441 extracts any normal images given the “visual inspection result: OK”.

The example of FIG. 6 illustrates that the inspection image 630 among the inspection images 610 to 630 of each region is given the “visual inspection result: BAD”. Therefore, the training dataset generation unit 441 extracts the inspection images 610 and 620 (Normal images given the “visual inspection result: OK”) of each region to generate a training dataset 640.

As illustrated in FIG. 6, the training dataset 640 has “ID”, “inspection image”, and “visual inspection result”, “CAD data”as items of information.

An identifier identifying the inspection image (normal image) is stored as the “ID”. The inspection image (normal image) of each region is stored as “inspection image”. The visual inspection result of the inspection image (normal image) of each region is stored as “visual inspection result”. Since only the normal images given the “visual inspection result: OK” are stored in the training dataset 640, only “OK” is stored as the “visual inspection result”.

### (2) Specific Example of Processing Performed by Training Unit

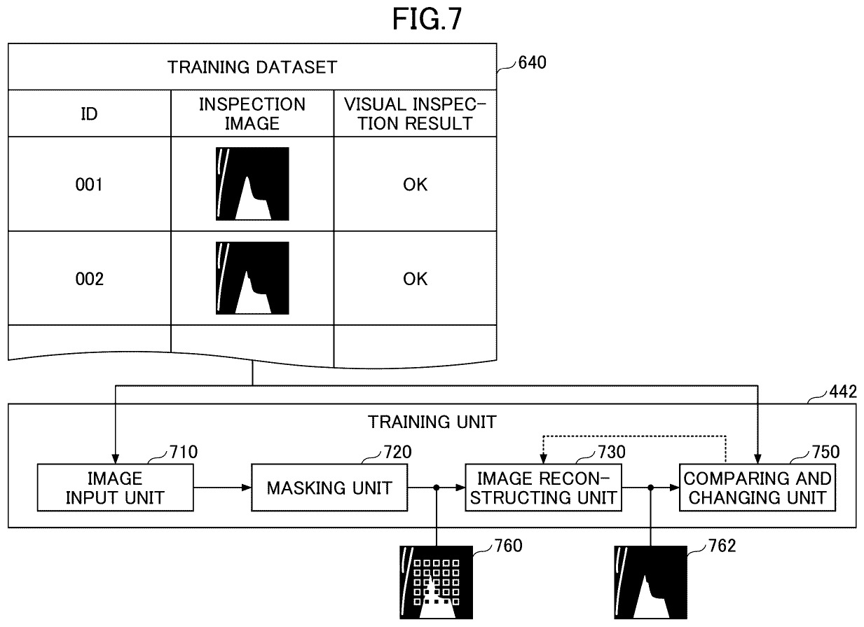

FIG. 7 illustrates a specific example of processing performed by the training unit of the training apparatus. As illustrated in FIG. 7, the training unit 442 includes an image input unit 710, a masking unit 720, an image reconstructing unit 730, and a comparing and changing unit 750.

The image input unit 710 reads the inspection image (Example of first image. For example, inspection image 610 (normal image)) of each region stored as the “inspection image” of the training dataset 640 stored in the training dataset storage unit 443, and inputs them into the masking unit 720.

The masking unit 720 generates a masked normal image (Example of first mask image. For example, masked normal image 760) by overlaying the first mask generated in advance onto the inspection region of the inspection image input by the image input unit 710. Further, the masking unit 720 inputs the generated masked normal image 760 into the image reconstructing unit 730.

The image reconstructing unit 730 performs reconstruction based on the masked normal image 760, and outputs a reconstruction image (Example of first reconstruction image. For example, reconstruction image 762).

The comparing and changing unit 750 compares the reconstruction image 762 reconstructed by the image reconstructing unit 730 with the inspection image (Normal image. For example, inspection image 610) read out by the image input unit 710, and updates the model parameters of the image reconstructing unit 730 so that they match.

Thus, the image reconstructing unit 730 performs training processing such that, in a case where the reconstruction image 762 is reconstructed from the masked normal image 760, this reconstruction image 762 more closely resembles the inspection image (normal image).

It is to be noted that the trained image reconstructing unit in which training processing is performed such that the reconstruction image more closely resembles the inspection image (normal image) is used in an inspection phase described below.

As described, according to the training unit 442, a training image generation AI that is capable of reconstructing a partial shape change in the inspection target object that arose due to a manufacturing variation that is within the acceptable range of a defect-free product can be generated.

### <System Configuration of Inspection System (Inspection Phase)>

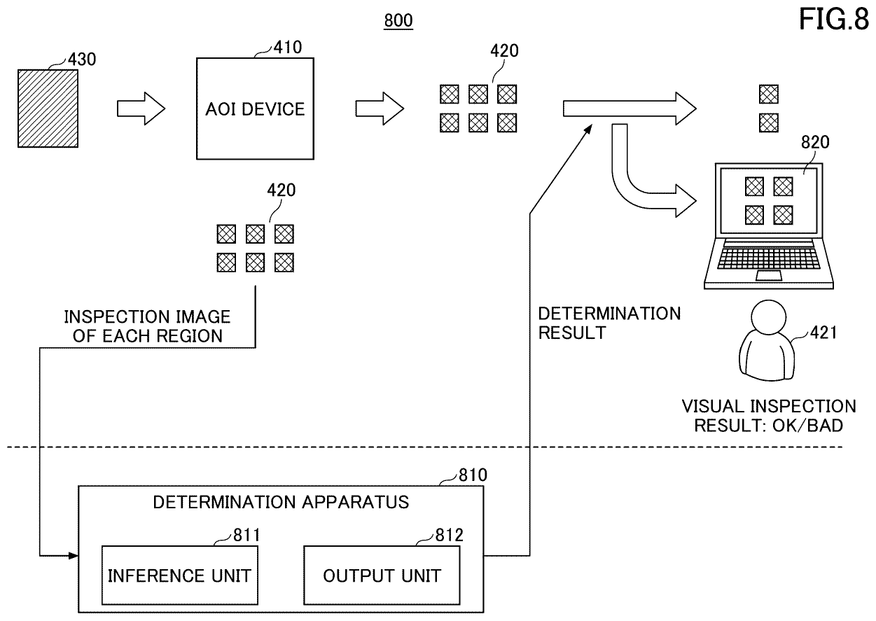

Next, the system configuration of the inspection system according to the first embodiment in an inspection phase is described. FIG. 8 illustrates an example of the system configuration of the inspection system in the inspection phase according to the first embodiment.

As illustrated in FIG. 8, an inspection system 800 in the inspection phase includes the AOI device 410 and a determination apparatus 810.

Among these, the AOI device 410 is the same as the AOI device 410 of the inspection system 400 in the training phase, so description is omitted here.

A determination program is installed in the determination apparatus 810, and when this program is executed, the determination apparatus 810 functions as an inference unit 811 and an output unit 812.

The inference unit 811 includes a trained image reconstructing unit generated in the training phase. The inference unit 811 acquires an inspection image 420 of each region transmitted from the AOI device 410 by performing automatic visual inspection on the inspection target object (printed circuit board 430, for example). Further, the inference unit 811 generates multiple masked inspection images (example of multiple second reconstruction images) by successively overlaying the first mask and the multiple second mask images onto the inspection region of the acquired inspection image 420 (Example of second image) of each region. Further, the inference unit 811 reconstructs the multiple reconstruction images (Example of multiple second reconstruction images) by successively inputting the multiple generated masked inspection images into the trained image reconstructing unit. Further, the inference unit 811 generates a synthesized image (Example of second synthesized image) by synthesizing the multiple reconstruction images. Further, the inference unit 811 determines whether or not the inspection image 420 of each region contains a defect by comparing the synthesized image with the inspection image 420. Further, the inference unit 811 notifies the output unit 812 of the determination result.

The output unit 812 outputs the determination result reported by the inference unit 811 to the inspection line. In the inspection line, the human inspector 421 performs visual inspection of the inspection image of each region containing the defect candidate. However, in the inspection phase, a determination result output by the output unit 812 is referred to, and the inspection images determined not to contain a defect by the determination apparatus 810 among the inspection images 420 of each region containing the defect candidate are excluded. Then, in the inspection line, the inspection images 820 determined to contain a defect by the determination apparatus 810 among the inspection images 420 of each region containing the defect candidate are designated to be visually inspected. In other words, the output unit 812 outputs the inspection images 820 to perform visual inspection of the inspection images 820 determined to contain a defect.

As described above, when automatic visual inspection is performed on the inspection target object in the AOI device 410 and the inspection images 420 of each region containing a defect candidate are detected, the inspection line designates the inspection images determined to contain the defect by the determination apparatus 810 to be visually inspected. As a result, according to the inspection system 800, the number of inspection images designated for visual inspection can be reduced, and the workload of the visual inspection by the human inspector 421 can be reduced.

### <Hardware Configuration of Determination Apparatus>

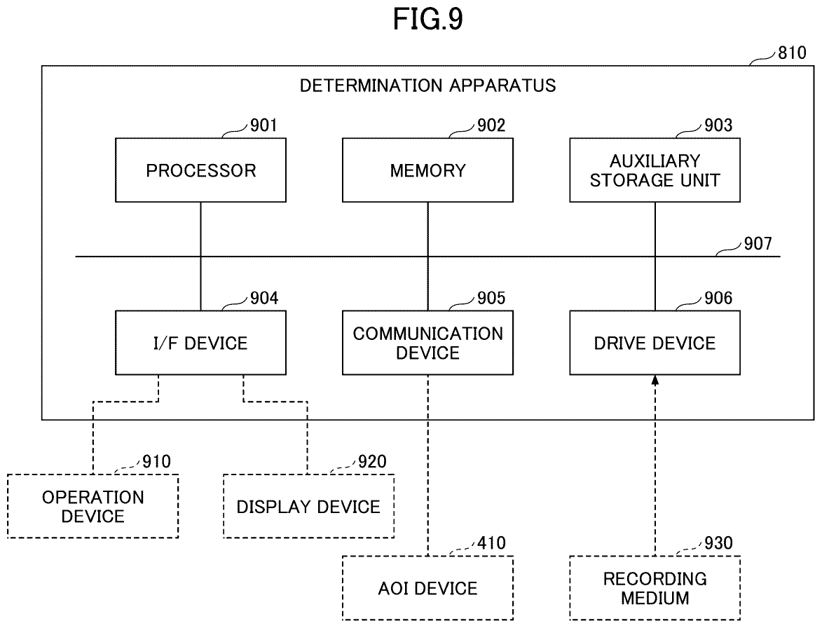

Next, the hardware configuration of the determination apparatus 810 is described. FIG. 9 is a diagram illustrating an example of the hardware configuration of the determination apparatus. As illustrated in FIG. 9, the hardware configuration of the determination apparatus 810 is almost the same as the hardware configuration of the training apparatus 440. Therefore, the following description will focus on the differences from the hardware configuration of the training apparatus 440.

As illustrated in FIG. 9, a processor 901 reads various programs (determination program, for example) into a memory 902 and executes them. By the processor 901 executing the various programs read into the memory 902, the computer formed by the processor 901 and the memory 902 achieves, for example, the aforementioned functions (inference unit 811 and output unit 812).

### <Details of Each Unit of Determination Apparatus>

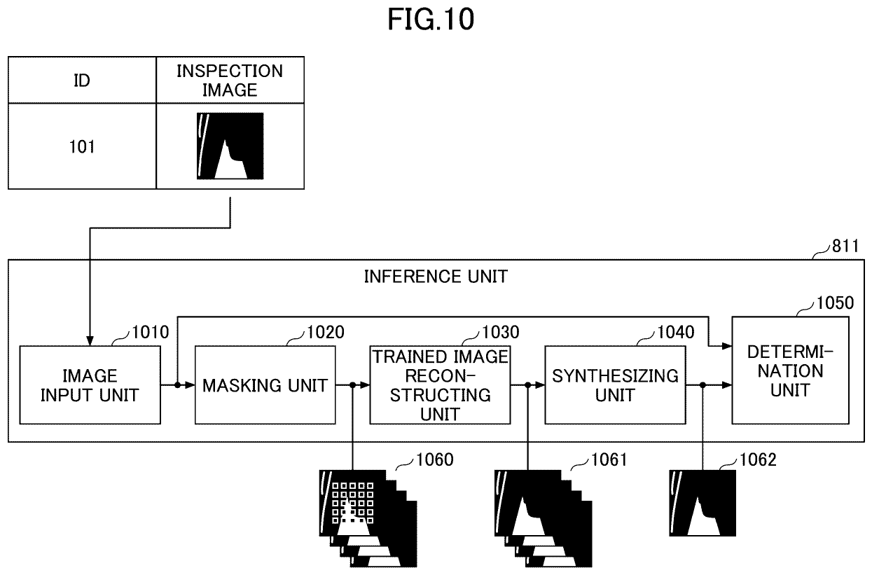

Next, details of each unit (here, inference unit 811) of the determination apparatus 810 is described. FIG. 10 is a diagram illustrating a specific example of processing performed by the inference unit of the determination apparatus. As illustrated in FIG. 10, the inference unit 811 includes an image input unit 1010, a masking unit 1020, a trained image reconstructing unit 1030, a synthesizing unit 1040, and a determination unit 1050.

The image input unit 1010 acquires the inspection image 420 of each region transmitted from the AOI device 410, and inputs the acquired inspection image into the masking unit 1020.

The masking unit 1020 successively overlays the first mask and the three types of the second mask onto the inspection region of the inspection image input by the image input unit 1010 to generate four masked inspection images (for example four masked inspection images 1060). Further, the masking unit 1020 inputs the four masked inspection images 1060 into the trained image reconstructing The trained image reconstructing unit 1030 is a trained model generated by performing training processing on the image reconstructing unit 730 in the training phase. The trained image reconstructing unit 1030 reconstructs four reconstruction images (for example, four reconstruction images 1061) based on the four masked inspection images 1060.

The synthesizing unit 1040 generates a synthesized image (for example, synthesized image 1062) by synthesizing the four reconstruction images 1061 reconstructed by the trained image reconstructing unit 1030. Also, the synthesizing unit 1040 notified the determination unit 1050 of the generated synthesized image 1062.

The determination unit 1050 compares the inspection image input by the image input unit 1010 with the synthesized image 1062 reported by the synthesizing unit 1040, and determines whether or not the inspection image contains a defect.

Specifically, the determination unit 1050 calculates the mean square error (MSE) of pixel values of corresponding pixels between the synthesized image and the inspection image. Subsequently, the determination unit 1050 determines whether the calculated MSE is less than or equal to a predetermined threshold (Th). If it is determined that the calculated MSE is less than or equal to the predetermined threshold, it is determined that the inspection image read by the image input unit 1010 does not contain a defect. On the other hand, if it is determined that the calculated MSE exceeds a predetermined threshold, it is determined that the inspection image input by the image input unit 1010 contains a defect.

In this way, the inference unit 811 can reconstruct a partial shape change in the inspection target object that arose due to a manufacturing variation that is within the acceptable range of a defect-free product, and thus the error between inspection image and the synthesized image can be made smaller.

Therefore, according to the inference unit 811, the issue of the inspection image being falsely determined to contain a defect even though there is no defect no longer happens, and thus false positive determinations can be reduced.

### <Flow of Training Processing>

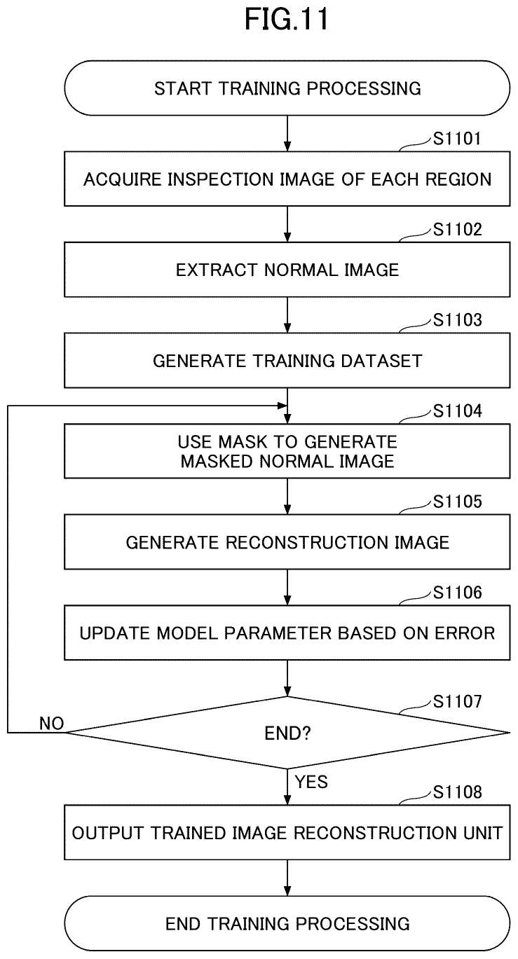

Next, a flow of training processing performed by the training apparatus 440 of the inspection system 400 is described. FIG. 11 is a flowchart illustrating the flow of training processing performed by the training apparatus of the inspection system according to the first embodiment.

In step S1101, the training dataset generation unit 441 of the training apparatus 440 acquires, from the AOI device 410, an inspection image 420 of each region containing a defect candidate.

In step S1102, the training dataset generation unit 441 of the training apparatus 440 extracts a normal image given the “visual inspection result: OK” among the acquired inspection images 420 of each region.

In step S1103, the training dataset generation unit 441 of the training apparatus 440 generates a training dataset.

In step S1104, the training unit 442 of the training apparatus 440 generates a masked normal image by overlaying the first mask onto the inspection region of the inspection image (normal image) of each region included in the training dataset.

In step S1105, the training unit 442 of the training apparatus 440 reconstructs the reconstruction image from the generated masked normal image.

In step S1106, the training unit 442 of the training apparatus 440 performs training processing on the image reconstructing unit by updating the model parameters of the image reconstructing unit such that the reconstructed reconstruction image more closely resembles the inspection image (normal image).

In step S1107, the training unit 442 of the training apparatus 440 determines whether to end the training processing. If it is determined in step S1107 that the training processing is to be continued (if NO in step S1107), the process returns to step S1103.

Conversely, if it is determined in step S1107 that the training processing is to be ended (if YES in step S1107), the process proceeds to step S1108.

In step S1108, the training unit 442 of the training apparatus 440 outputs the trained image reconstructing unit and ends the training processing.

### <Flow of Determination Processing>

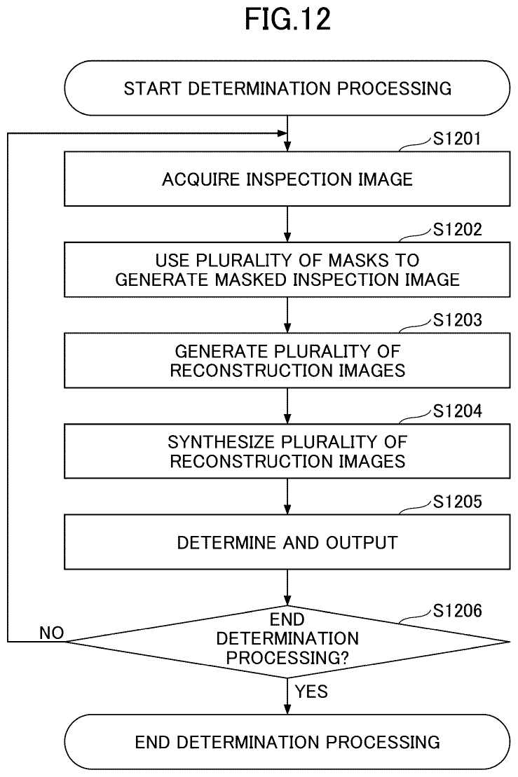

Next, the flow of determination processing performed by the determination apparatus 810 of the inspection system 800 is described. FIG. 12 is a flowchart illustrating the flow of determination processing performed by the determination apparatus of the inspection system according to the first embodiment.

In step S1201, the inference unit 811 of the determination apparatus 810 acquires an inspection image 420 of each region containing a defect candidate from the AOI device 410.

In step S1202, the inference unit 811 of the determination apparatus 810 generates multiple masked inspection images by overlaying the first mask and the multiple second masks onto the inspection region of the acquired inspection image 420 of each region.

In step S1203, the inference unit 811 of the determination apparatus 810 reconstructs multiple reconstruction images by inputting the multiple generated masked inspection images into the trained image reconstructing unit.

In step S1204, the inference unit 811 of the determination apparatus 810 generates a synthesized image by synthesizing the multiple reconstructed reconstruction images.

In step S1205, the inference unit 811 of the determination apparatus 810 determines whether or not the inspection image contains a defect by comparing the inspection image acquired in step S1201 with the synthesized image generated in step S1204 and calculating the MSE. Further, the inference unit 811 of the determination apparatus 810 outputs the determination result.

In step S1206, the inference unit 811 of the determination apparatus 810 determines whether or not to end the determination processing. In step S1206, if it is determined that the determination processing is to be continued (if NO in step S1206), the process returns to step S1201.

Conversely, in step S1206, if it is determined that the determination processing is to be ended (if YES in step S1206), the determination processing is ended.

### <Verification by Inference Unit>

Next, the inference unit 811 of the determination apparatus 810 is used to reconstruct a reconstruction image and verify the generation accuracy in a case where a synthesized image is generated. The verification of the generation accuracy of the synthesized is performed using the following procedure:
1) A comparative device is prepared.
2) Different training datasets are generated by overlaying different first masks onto the same normal image and then training is performed using each of the training datasets to generate:
(a trained image reconstructing unit of) an inference unit of the comparative device, and
(the trained image reconstructing unit 1030 of) the inference unit 811 of the determination apparatus 810.
3) A reconstruction image is reconstructed and a synthesized image is generated by inputting the same inspection image into the inference unit of the comparative device and the inference unit 811 of the determination apparatus 810.
4) An error between the input inspection image and the synthesized image generated in the inference unit of the comparative device and an error between the input inspection image and the synthesized image generated in the inference unit 811 of the determination apparatus 810 are calculated.
5) Aforementioned 3) and 4) are repeated for multiple inspection images and average values of errors are compared to verify the generation accuracy of the synthesized image.

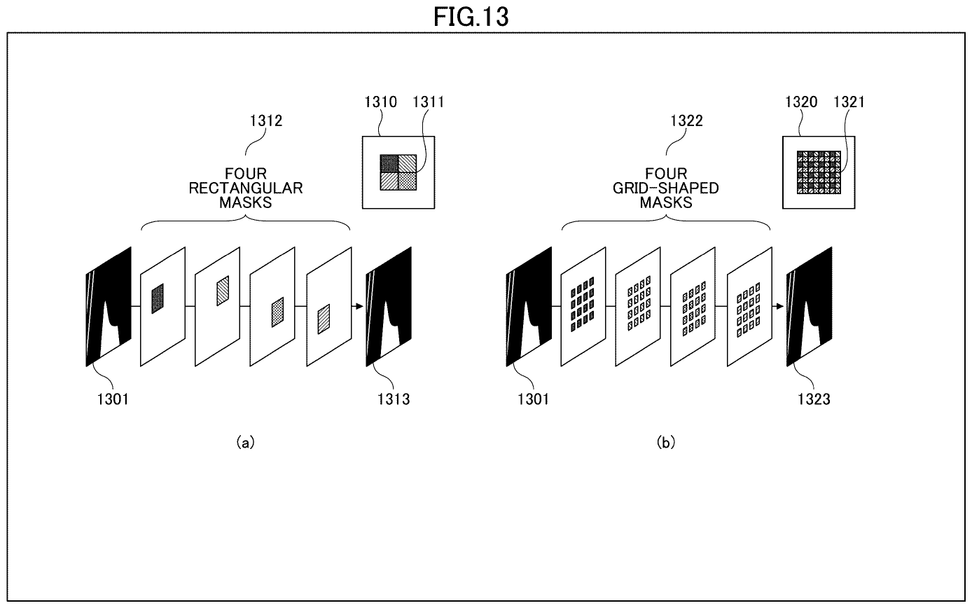

FIG. 13 is a diagram for describing an overview of the verification processing. Section (a) of FIG. 13 illustrates an overview of processing performed by the inference unit of the comparative device. As illustrated by reference numeral 1310, the inference unit of the comparative device uses four rectangular masks (one first mask and three second masks, each containing one rectangular mask piece) to be overlaid onto each of four divided regions of the inspection region 1311 to generate a masked verification image.

Specifically, as denoted by reference numeral 1312, the inference unit of the comparative device generated four masked verification images by overlaying each of the four rectangular masks onto an inspection image 1301.

Next, the inference unit of the comparative device reconstructs the reconstruction image based on each of the four generated masked inspection images and generates a synthesized image 1313. Further, the inference unit of the comparative device calculates an error between the inspection image 1301 and the synthesized image 1313.

In contrast to this, section (b) in FIG. 13 illustrates an overview of the processing performed by the inference unit 811 of the determination apparatus 810. As denoted by reference numeral 1320, the inference unit 811 of the determination apparatus 810 uses four grid-shaped masks (one first mask and three second masks, each containing multiple mask pieces arranged in a grid shape) to be overlaid onto an inspection region 1321 and to a masked inspection image.

Specifically, as denoted by reference numeral 1322, the inference unit 811 of the determination apparatus 810 generates four masked verification images by overlaying four grid-shaped masks onto each inspection image 1301.

Next, the inference unit 811 of the determination apparatus 810 reconstructs a reconstruction image based on each of the four generated masked inspection images and generates a synthesized image 1323. Further, the inference unit 811 of the determination apparatus 810 calculates an error between the inspection image 1301 and the synthesized image 1323.

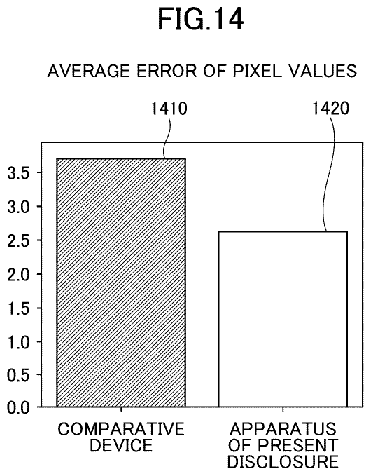

FIG. 14 is a diagram illustrating an example of verification results. In FIG. 14, reference numeral 1410 depicts an average value of errors of pixel values per pixel between the multiple inspection images and multiple synthesized images generated by the inference unit of the comparative device based on the multiple inspection images.

Also, in FIG. 14, reference numeral 1420 depicts an average value of errors of pixel values per pixel between the multiple inspection images and multiple synthesized images generated by the inference unit 811 of the determination apparatus 810 based on the multiple inspection images.

Comparing the average value (=3.69) of errors depicted by reference numeral 1410 with the average value (=2.61) of errors depicted by reference numeral 1420, the average value depicted by 1420 was reduced by 29.3% compared to the average error depicted by reference numeral 1410. This indicates that the inference unit 811 of the determination apparatus 810 has a higher accuracy in generating synthesized images than the inference unit of the comparative device.

By improving the accuracy in generating synthesized images by the inference unit 811 of the determination apparatus 810, the risk of falsely determining a normal image as an abnormal image can be reduced.

As is clear from the above description, the inspection system 400 according to the first embodiment
The first mask is generated by orderly arranging multiple mask pieces smaller than a mask to be overlaid onto an inspection region such that neighboring mask pieces among the multiple mask pieces have a predetermined space therebetween in the vertical direction, the horizontal direction, and the diagonal direction.
The second mask in which multiple mask pieces are orderly arranged at positions so as to occupy the predetermined spaces of the first mask in the vertical direction, the horizontal direction, and the diagonal direction in a quantity corresponding to the size of the spaces.
A masked normal image is generated by overlaying the first mask onto the inspection region of the normal image determined not to contain a defect among captured images of the inspection target object.
A reconstruction image is reconstructed by inputting the generated masked normal image, training processing is performed on the image reconstructing unit such that the reconstructed reconstruction unit more closely resembles the inspection image (normal image), and thus the trained image reconstructing unit is generated.

By doing so, the inspection system 400 according to the first embodiment can generate a training image generation AI that is capable of reconstructing a partial shape change in the inspection target object that arose due to a manufacturing variation that is within the acceptable range of a defect-free product.

Also, the inspection system 800 according to the first embodiment:
generates multiple masked inspection images by successively overlaying the first mask and multiple second masks onto an inspection region of an inspection image obtained by image capturing the inspection target object,
generates a synthesized image by synthesizing multiple reconstruction images, in a case where multiple reconstruction images are reconstructed by inputting multiple generated masked inspection images into the trained image reconstructing unit.
The synthesized image is compared with the inspection image and a determination is made as to whether or not the inspection image contains a defect.

By doing so, the inspection system 800 according to the first embodiment can reconstruct a partial shape change in the inspection target object that arose due to a manufacturing variation that is within the acceptable range of a defect-free product can be generated, and thus the error between the inspection image and the synthesized image can be made smaller. As a result, according to the inspection system 800 of the first embodiment, the issue of the inspection image being falsely determined to contain a defect even though there is no defect no longer happens, and thus false positive determinations can be reduced.

### Second Embodiment

In the aforementioned first embodiment, the first mask is generated by orderly arranging multiple mask pieces smaller than a mask to be overlaid onto the inspection region such that neighboring mask pieces among the multiple mask pieces have a space therebetween equal in size to the small mask pieces in the vertical direction, the horizontal direction, and the diagonal direction. Also, in the first embodiment, three types of the second mask are generated by orderly arranging multiple mask pieces at positions so as to occupy the predetermined spaces equal in size to the mask pieces in the vertical direction, the horizontal direction, and the diagonal direction.

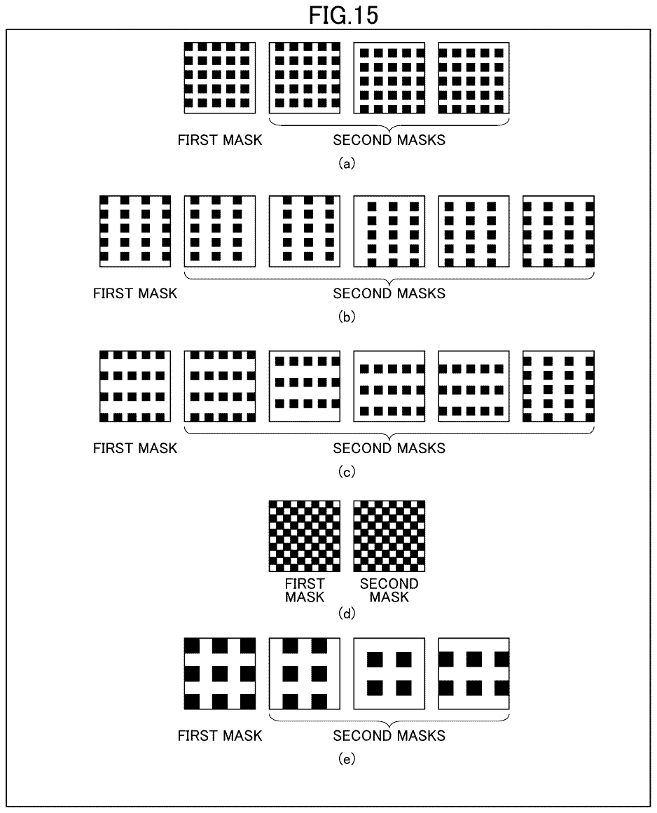

However, the first mask and the multiple second masks are not limited to this generation method. FIG. 15 is a diagram illustrating other examples of a first mask and multiple second masks. Among these, section (a) of FIG. 15 illustrates the first mask and the three types of the second mask indicated in the first embodiment for the sake of comparison.

In contrast to this, section (b) of FIG. 15 illustrates:
a first mask in which multiple mask pieces smaller in size than a mask to be overlaid onto the inspection region are arranged such that neighboring mask pieces among the multiple mask pieces have a space therebetween that is the equal in size to the mask pieces in the vertical direction and a space therebetween that is twice the size of the mask pieces in the horizontal direction and the diagonal direction, and
one type of the second mask in which multiple mask pieces are orderly arranged at positions so as to occupy spaces that are equal in size to the mask pieces in the vertical direction and five types of the second mask in which multiple mask pieces are orderly arranged at positions so as to occupy spaces twice the size of the mask pieces in the horizontal direction and the diagonal direction.

Also, section (c) of FIG. 15 illustrates:
a first mask in which multiple mask pieces smaller in size than a mask to be overlaid onto the inspection region are arranged such that neighboring mask pieces among the multiple mask pieces have a space therebetween that is twice the size of the mask pieces in the vertical direction and the diagonal direction and a space therebetween that is equal in size to the mask pieces in the horizontal direction, and
one type of the second mask in which multiple mask pieces are orderly arranged at positions so as to occupy spaces that are equal in size to the mask pieces in the horizontal direction and five types of the second mask in which multiple mask pieces are orderly arranged at positions so as to occupy spaces twice the size of the mask pieces in the vertical direction and the diagonal direction.

Also, section (d) of FIG. 15 illustrates:
a first mask in which multiple mask pieces smaller in size than a mask to be overlaid onto the inspection region are arranged such that neighboring mask pieces among the multiple mask pieces have a space therebetween that is equal in size to the mask pieces in the vertical direction and a space therebetween that is equal in size to the mask pieces in the horizontal direction, and
one type of the second mask in which multiple mask pieces are orderly arranged at positions so as to occupy spaces that are equal in size to the mask pieces in the horizontal direction and the vertical direction.

Also, section (e) of FIG. 15 illustrates:
a first mask in which multiple mask pieces smaller in size than a mask to be overlaid onto the inspection region yet larger in size than the mask pieces illustrated in sections (a) to (d) in FIG. 15 are arranged such that neighboring mask pieces among the multiple mask pieces have a space therebetween that is equal in size to the mask pieces in the vertical direction, the horizontal direction, and the diagonal direction, and
three types of the second mask in which multiple mask pieces are orderly arranged at positions so as to occupy spaces equal in size to of the mask pieces in the horizontal direction, the vertical direction, and the diagonal direction.

As described above, there are many methods for generating the first mask and multiple second mask, and a determined by taking into account factors such as the size of the acquired inspection images and the size of defects contained in the inspection images.

### Third Embodiment

The masking unit 720 in the training apparatus 440 of the aforementioned first embodiment was described as an apparatus that generates masked normal images by using the first mask. However, the method for generating the masked normal image is not limited to this, and, for example, any of the multiple second masks may be used to generate the masked normal image.

Also, the masking unit 720 in the training apparatus 440 according to the aforementioned first embodiment was described as an apparatus that performs training processing on the image reconstructing unit 730 by generating a masked normal image by using one type of mask. However, the method of training processing on the image reconstructing unit 730 is not limited to this, and training processing may be performed by generating the masked normal image by using multiple types of masks (for example, a first mask and a second mask or multiple second masks).

Also, in the training apparatus 440 of the aforementioned first embodiment, no synthesizing unit is provided. However, the configuration of the training apparatus 440 is not limited to this, and the training apparatus 440 may have a synthesizing unit as does the determination apparatus 810. In such a case, the training apparatus 440 inputs multiple masked normal images generated by successively overlaying the first mask and the multiple second masks into the image reconstructing unit 730, and generates a synthesized image by the synthesizing unit synthesizing the multiple reconstruction images generated by the image reconstructing unit 730. By doing so, the training apparatus 440 performs training processing on the image reconstructing unit 730 such that the synthesized image more closely resembles the inspection image (normal image).

In the first embodiment, the position of the inspection region where the first mask and the multiple second masks are overlaid is not described, but it is assumed that the AOI device 410 adjusts the inspection region so that it is in the center of the inspection image. In the first embodiment, the size of the mask to be overlaid is not described, but it is assumed that the size of the mask to be overlaid is adjusted according to the size of the inspection region of the inspection image transmitted from the AOI device 410. However, no restriction is imposed regarding the position of the inspection region where the mask is overlaid and its size, and masks of any position and size can be overlaid.

In the first embodiment, the details of processing for determining whether or not the inspection image contains a defect by performing image processing using the inspection image and reconstruction image are not described, but such processes include, for example, the following processing.
The absolute value of the difference between the inspection image and reconstruction image for each pixel is calculated, and a difference image is generated.
A region where the absolute value of the difference is greater than or equal to a threshold value is extracted by performing binarization processing on the difference image.
Contour extraction processing is performed on the difference image after binarization processing, and the contour of the region where the absolute value of the difference is greater than or equal to a threshold value is extracted.
If the shape and size of the extracted contour satisfy the pre-determined conditions, it is determined that there is a defect. If the shape and size of the extracted contour do not satisfy the pre-determined conditions, it is determined that there is no defect.

Thus, by determining whether or not an inspection image contains a defect based on the result of image processing, the determination accuracy can be improved compared with the case of making a determination based on the magnitude of the error.

The present invention is not limited to the configurations described in connection with the embodiments that have been described heretofore, or to the combinations of these configurations with other elements. Various variations and modifications may be made without departing from the scope of the present invention, and may be adopted according to applications.

This application is based on and claims priority to Japanese Patent Application No. 2023-054111, filed on Mar. 29, 2023, the entire contents of which are incorporated herein by reference.

### REFERENCE SIGNS LIST

400 Inspection system
410 AOI device
440 Training apparatus
441 Training dataset generation unit
442 Training unit
640 Training dataset
710 Image input unit
720 Masking unit
730 Image reconstructing unit
750 Comparing and changing unit
810 Determination apparatus
811 Inference unit
812 Output unit
1010 Image input unit
1020 Masking unit
1030 Trained image reconstructing unit
1040 Synthesizing unit
1050 Determination unit

1. A determination apparatus, comprising:
a trained image reconstructing unit trained such that a first reconstruction image more closely resembles a first image and configured to output the first reconstruction image, in a case where a first mask image is input into the trained image reconstructing unit, the first mask image being generated by overlaying a mask onto an inspection region of the first image, the first image being an image determined not to contain a defect among captured images of an inspection target object;
a synthesizing unit configured to generate a second synthesized image by synthesizing a plurality of second reconstruction images in a case where the plurality of second reconstruction images are reconstructed by inputting a plurality of second mask images into the trained image reconstructing unit, the plurality of second mask images generated by a plurality of masks being successively overlaid onto an inspection region of a second image, the second image being a captured image of the inspection target object; and
a determination unit configured to compare the second synthesized image with the second image to determine whether or not the second image contains a defect.

2. The determination apparatus according to claim 1, wherein
the plurality of masks include a first mask and a plurality of second masks,
the first mask is generated by orderly arranging a plurality of mask pieces such that neighboring mask pieces of the plurality of mask pieces have a predetermined space therebetween in a vertical direction, a horizontal direction, and a diagonal direction, each mask piece being smaller in size than a mask to be overlaid onto the inspection region, and
the plurality of second masks are generated in a quantity corresponding to a size of spaces by orderly arranging a plurality of mask pieces at positions so as to occupy predetermined spaces in the vertical direction, predetermined spaces in the horizontal direction, and predetermined spaces in the diagonal direction of the first mask.

3. The determination apparatus according to claim 1, wherein
the plurality of masks include a first mask and a plurality of second masks,
the first mask is generated by orderly arranging a plurality of mask pieces such that neighboring mask pieces of the plurality of mask pieces have a predetermined space therebetween in a vertical direction and a horizontal direction, each mask piece being smaller in size than a mask to be overlaid onto the inspection region, and
the plurality of second masks are generated in a quantity corresponding to a size of spaces by orderly arranging a plurality of mask pieces at positions so as to occupy predetermined spaces in the vertical direction and predetermined spaces in the horizontal direction of the first mask.

4. The determination apparatus according to claim 2, wherein the predetermined spaces are an integer multiple of a size of the mask piece.

5. The determination apparatus according to claim 1, wherein
the determination unit
determines that the second image does not contain a defect in a case where a value calculated based on an error of pixel values of corresponding pixels between the second image and the second synthesized image satisfies a predetermined condition, and
determines that the second image contains a defect in a case where the value calculated based on the error of pixel values of corresponding pixels between the second image and the second synthesized image does not satisfy the predetermined condition.

6. A training apparatus, comprising:
a masking unit configured to generate a first mask image by overlaying a mask onto an inspection region of a normal image, the normal image being an image determined not to contain a defect among captured images of an inspection target object; and
an image reconstructing unit configured to output a first reconstruction image in a case where the first mask image is input into the image reconstructing unit,
wherein the mask is generated by orderly arranging a plurality of mask pieces such that neighboring mask pieces of the plurality of mask pieces have a predetermined space therebetween in at least a vertical direction and a horizontal direction, each mask piece being smaller in size than a mask to be overlaid onto the inspection region, and
the image reconstructing unit is trained such that the first reconstruction image more closely resembles the normal image.

7. The training apparatus according to claim 6, wherein the mask is generated by orderly arranging a plurality of mask pieces such that neighboring mask pieces of the plurality of mask pieces have a predetermined space therebetween in the vertical direction, the horizontal direction, and a diagonal direction, each mask piece being smaller in size than the mask to be overlaid onto the inspection region.

8. A determination method executed by a computer of a determination apparatus storing therein a trained image reconstructing unit that is trained such that a first reconstruction image more closely resembles a first image and configured to output the first reconstruction image, in a case where a first mask image is input into the trained image reconstructing unit, the first mask image being generated by overlaying a mask onto an inspection region of the first image, the first image being an image determined not to contain a defect among captured images of an inspection target object, the determination method comprising:
generating a second synthesized image by synthesizing a plurality of second reconstruction images in a case where the plurality of second reconstruction images are reconstructed by inputting a plurality of second mask images into the trained image reconstructing unit, the plurality of second mask images generated by a plurality of masks being successively overlaid onto an inspection region of a second image, the second image being a captured image of the inspection target object; and
comparing the second synthesized image with the second image to determine whether or not the second image contains a defect.

9. A training method executed by a computer of a training apparatus, the training method comprising:
generating a first mask image by overlaying a mask onto an inspection region of a normal image determined not to contain a defect among captured images of an inspection target object; and
outputting, by an image reconstructing unit, a first reconstruction image, in a case where the first mask image is input into the image reconstructing unit,
wherein the mask is generated by orderly arranging a plurality of mask pieces such that neighboring mask pieces of the plurality of mask pieces have a predetermined space therebetween in at least a vertical direction and a horizontal direction, each mask piece being smaller in size than a mask to be overlaid onto the inspection region, and
wherein, in the outputting, training processing is performed on the AI image reconstructing unit such that the first reconstruction image more closely resembles the first image.

10. A determination program for causing a computer, in a determination apparatus storing therein a trained image reconstructing unit, trained such that a first reconstruction image more closely resembles a first image and configured to output the first reconstruction image, in a case where a first mask image is input into the trained image reconstructing unit, the first mask image being generated by overlaying a mask onto an inspection region of the first image, the first image being an image determined not to contain a defect among captured images of an inspection target object, to:
generate a second synthesized image by synthesizing a plurality of second reconstruction images in a case where the plurality of second reconstruction images are reconstructed by inputting a plurality of second mask images into the trained image reconstructing unit, the plurality of second mask images generated by a plurality of masks being successively overlaid onto an inspection region of a second image, the second image being a captured image of the inspection target object; and
compare the second synthesized image with the second image to determine whether or not the second image contains a defect.

11. A training program causing a computer in a training apparatus to:
generate a first mask image by overlaying a mask onto an inspection region of a normal image determined not to contain a defect among captured images of an inspection target object; and
output, by an image reconstructing unit, a first reconstruction image, in a case where the first mask image is input into the image reconstructing unit,
wherein the mask is generated by orderly arranging a plurality of mask pieces such that neighboring mask pieces of the plurality of mask pieces have a predetermined space therebetween in at least a vertical direction and a horizontal direction, each mask piece being smaller in size than a mask to be overlaid onto the inspection region, and
wherein, in the outputting, training processing is performed on the image reconstructing unit such that the first reconstruction image more closely resembles the first image.
